(19) United States
(12) Patent Application Publication
(10) Pub. No.: US 2010/0215308 A1
(43) Pub. Date: Aug. 26, 2010

(54) ELECTROABSORPTION MODULATORS WITH A WEAKLY GUIDED OPTICAL WAVEGUIDE MODE

(75) Inventor: David Graham Moodie, Suffolk (GB)

Correspondence Address: THORPE NORTH & WESTERN, LLP., P.O. Box 1219, SANDY, UT, 84091-1219, US

(73) Assignee: THE CENTRE FOR INTEGRATED PHOTONICS LIMITED, Suffolk (GB)

(21) Appl. No.: 12/721,318

(22) Filed: Mar. 10, 2010

Related U.S. Application Data
(63) Continuation-in-part of application No. PCT/GB2008/050806, filed on Sep. 10, 2008.

(30) Foreign Application Priority Data
Sep. 10, 2007 (GB) 0717606.8

(51) Int. Cl. G02F 1/017; G02F 1/025; G02F 1/015

(52) U.S. Cl. 385/2; 359/245

(57) ABSTRACT

An electroabsorption modulator comprises an absorption layer, at least one layer of p-doped semiconductor, and at least one layer of n-doped semiconductor, said absorption layer being provided between said at least one layer of p-doped semiconductor and said at least one layer of n-doped semiconductor, and said layers forming a ridge waveguide structure, wherein the thickness of said absorption layer is between 9 and 60 nm, the width of said absorption layer is between 4.5 and 12 microns, and the width of at least one of said at least one layer of p-doped semiconductor and said at least one layer of n-doped semiconductor is between 4.5 and 12 microns; whereby the width of said ridge waveguide structure is between 4.5 and 12 microns.

### PRIORITY CLAIM

This is a continuation-in-part of PCT patent application Serial No. PCT/GB2008/050806 filed on Sep. 10, 2008 which claims priority to GB Patent Application Serial No. 0717606.8, filed Sep. 10, 2007, which is hereby incorporated by reference herein in its entirety.

### FIELD OF THE INVENTION

The present invention relates to semiconductor optoelectronic components and in particular to electroabsorption modulators (EAM).

### BACKGROUND TO THE INVENTION

Electroabsorption modulators (EAMs) typically have optical absorption regions or more precisely defined as an absorption layer comprising multiple quantum wells (MQWs) or bulk semiconductor. In either case the typical absorption region (also known as the absorption layer) thickness is generally in the range of 0.12-0.28 μm with the MQW devices typically having 8-15 wells. They are generally waveguide devices in which the absorption region (also known as the absorption layer) also serves as an optical waveguiding layer. These typical thicknesses result in a relatively tightly confined mode which is efficient in that a high overlap of electrical and optical fields is achieved in the absorption region (also know as the absorption layer). A disadvantage however is that the mode size in the modulator is generally significantly smaller than that of single mode fibre.

Commonly used approaches to overcome this disadvantage use either a lens-ended fibre or a free space lens to increase the coupling efficiency. This makes the packaging process relatively expensive as the alignment tolerances are relatively small.

Another approach is to use a waveguide taper to increase the mode size of the EAM at the facet. There have been several designs proposed for producing ‘large spot’ active semiconductor optoelectronic devices (e.g. lasers, semiconductors, photodiodes, modulators); that incorporate optical mode transformers (see I. Lealman et al, “1.5 μm InGaAsP/InP large mode size laser for high coupling efficiency to cleaved single mode fibre”, Semiconductor Laser Conference, 1994., 14th IEEE International, 19-23 Sep. 1994 Page(s):189-190; and I. Moerman et al, “A review on fabrication technologies for the monolithic integration of tapers with III-V semiconductor devices”, IEEE Journal of Selected Topics in Quantum Electronics, Volume 3, Issue 6, December 1997 Page(s):1308-1320). These designs often necessitate multiple stages of photolithography and etching of the semiconductor, which reduces yields due to the necessary alignment tolerances, and often involve re-growth steps. The tapers also impact performance by adding around 1-3 dB of optical loss per taper.

More recently a ‘large spot’ EAM design which did not incorporate optical mode transformers but instead used a peripheral coupled optical modulator design has been reported (Zhuang Y et al, “Peripheral coupled waveguide travelling-wave electroabsorption modulator”, 2003 IEEE mtt-s international microwave symposium digest. (IMS 2003) Philadelphia, Jun. 8-13 2003, vol. 2, page 1367-1370.). FIG. 1 in the Zhuang paper shows the structure of their peripheral coupled waveguide device. The lower mesa that is −10 microns wide comprises the ‘upper cladding’, ‘optical core’ and ‘lower cladding layers’—in other words the function of these layers is to form a passive optical waveguide underlying the active part of the device. The active ‘EA layer’ (the absorption layer) is located on top of this wide mesa and is relatively narrow. The actual width of the absorption layer is not disclosed, but is clearly less than the full ˜10 microns lower mesa width as the n-contacts are shown on the top surface of the lower mesa and you would have to etch through the absorption layer to reach the n-contacts. They say ‘the microwave transmission line including the EA region, is placed only peripheral to the optical waveguide mode, in its evanescent field’ and ‘The optical waveguide will have large mode size to match to the single mode fiber mode’. An EAM suitable for 10 Gbit/s modulation with only four quantum wells, each 13 nm thick with 5 nm thick barriers in a buried heterostructure geometry has been reported (K. Wakita et al, “Very low insertion loss (<5 dB) and high speed InGaAs/InAIAs MQW modulators buried in semi-insulating InP” Optical Fibre Communications (OFC'97) Technical Digest, pp. 137-138, 1997). The thickness of the absorption layer in this document is approximately 67 nm if no outer barriers were present or approximately 77 nm if 2 outer barriers were present. A relatively dilute optical mode profile and <5 dB insertion loss was reported in a 40 Gbit/s buried heterostructure EAM with 10 wells (D. G. Moodie et al, “Applications of electroabsorption modulators in high bit-rate extended reach transmission systems”, OFC 2003, Invited Paper TuP1, pp. 267-268, 2003).

A 2.2 μm wide ridge waveguide EAM test structure with three wells, each 8 nm thick has also been reported (I. K. Czajkowski et al, “Strain-compensated MQW electroabsorption modulator for increased optical power handling,” El. Lett., vol. 30, no. 11, pp. 900-901, 1994), although in this case the reason for only having three wells was ‘because of the problems associated with growing a large number of strained wells’. Ridge EAMs of width 2-4 μm and only five quantum wells, each 5.5 nm thick with 8 nm thick barriers have been reported (S. Oshiba et al, “Low drive voltage MQW electroabsorption modulator for optical short pulse generation,” IEEE JQE, vol. 34, no. 2, pp. 277-281, 1998). Again the ridge width is thought to be too narrow to expand the mode to get good matching to the output of a cleaved SMF-28® fibre. An early MQW EAM paper (T. H. Wood et al, “100 ps waveguide multiple quantum well (MQW) optical modulator with 10:1 on/off ratio,” El. Lett., vol. 21, no. 16, pp. 693-694, 1985) used two quantum wells each 9.4 nm thick in a 40 μm wide mesa, this mesa is so wide its performance was approximately that of a one-dimensional slab waveguide in cross-section and again this design is not expected to be suitable for low loss coupling to cleaved fibre.

The present invention, at least in its preferred embodiments, seeks to improve on known constructions.

### SUMMARY OF THE INVENTION

Accordingly, this invention provides an electroabsorption modulator comprising an absorption layer between at least one layer of p-doped semiconductor and at least one layer of n-doped semiconductor. The layers form a ridge waveguide structure. The thickness of the absorption layer is between 9 and 60 nm and the width of the ridge is between 4.5 and 12 microns.

In other words, an electroabsorption modulator comprises an absorption layer, at least one layer of p-doped semiconductor, and at least one layer of n-doped semiconductor, said absorption layer being provided between said at least one layer of p-doped semiconductor and said at least one layer of n-doped semiconductor, and said layers forming a ridge waveguide structure, wherein the thickness of said absorption layer is between 9 and 60 nm, the width of said absorption layer is between 4.5 and 12 microns, and the width of at least one of said at least one layer of p-doped semiconductor and said at least one layer of n-doped semiconductor is between 4.5 and 12 microns; whereby the width of said ridge waveguide structure is between 4.5 and 12 microns.

Thus, the invention provides an electroabsorption modulator with a relatively wide ridge structure and a relatively thin absorption layer. The absorption layer may in practice often be formed of MQWs with multiple layers the total thickness of which including the barriers of the MQWs falls within the range of absorption layer thickness cited above. Typically, ridge structures with such dimensions have not been used because of their relatively high capacitance. However, in accordance with the present invention, it has been found that the relatively thin absorption layer provides for a weakly guided optical mode that spreads out into the surrounding semiconductor material. The result is a relatively diffuse optical mode that is particularly well-suited for coupling into a single mode fibre. This advantage and the simplicity of construction of electroabsorption modulator are sufficient to overcome any disadvantages due to higher capacitance.

In contrast to the peripheral coupled waveguide design (Zhuang Y et al, “Peripheral coupled waveguide travelling-wave electroabsorption modulator”, 2003 IEEE mtt-s international microwave symposium digest. (IMS 2003) Philadelphia, Jun. 8-13 2003, vol. 2, page 1367-1370.) the relatively wide ridge waveguide defining the large optical mode preferably has the absorber layer extending across its full width. The wide mesa is preferably formed in the p-doped semiconductor, the absorption layer and usually part of the n-doped semiconductor layers. In other words the ridge is preferably formed by etching away the p-doped semiconductor, the absorption layer and usually part of the n-doped semiconductor layers from parts of the wafer adjacent to the ridge. (In practice the absorption layer may be narrower or wider by a few tenths of a micron than the other layers of the ridge but it is substantially the same width). This approach is thought to offer practical advantages as since the ridge is relatively wide it is relatively easy to fabricate and the optical mode shape and the optical confinement factor in the absorption layer are preferably not sensitive to small variations in the width of the absorption layer.

The absorption layer may be formed of bulk semiconductor. In the preferred embodiment, the absorption layer comprises multiple quantum wells. In the broadest definition of the invention, the thickness of the absorption layer comprises the multiple quantum wells including their inner and outer barriers.

The absorption layer may comprise three or fewer quantum wells, for example two or three quantum wells. The sum of the thicknesses of the multiple quantum wells may be greater than 9 nm and/or less than 40 nm. The sum of the thicknesses of the multiple quantum wells may not include the barriers in this measurement range. In particular embodiments, the sum of the thicknesses of the multiple quantum wells may be greater than 12 nm or even greater than 18 nm. Increasing the thickness of the quantum wells and thus the absorption layer reduces the capacitance of the absorption layer. However, if the absorption layer is too thick, the optical mode becomes flatter, which is less desirable for effective coupling into a single mode fibre. Thus, the sum of the thicknesses of the multiple quantum wells may be less than 30 nm or even less than 25 nm. Again, the sum of the thicknesses of the multiple quantum wells may not include the barriers in this measurement range.

In particular embodiments, the absorption layer may have a thickness greater than 20 nm. Similarly, in particular embodiments, the absorption layer may have a thickness less than 50 nm, less than 40 nm or even less than 23 nm. Typically, the absorption layer comprises multiple quantum wells; whereby the thickness referenced incorporates both the wells and their barriers. Typically, the absorption layer is a layer of relatively low doping. For example, the level of p and n-type dopants may be less than 1×10¹⁷ cm⁻³ in the absorption layer. In the layers of p-doped semiconductor and n-doped semiconductor, the level of p and n-type dopants is typically greater than 1×10¹⁷ cm⁻³.

A depletion region containing the absorption layer may include additional layers, in addition to the layer making up the multiple quantum wells absorption layer, for example. Whilst referring to the absorption layer, the skilled person knows that it may be in practice formed by multiple quantum wells which incorporate multiple layers by definition. It is possible for the depletion region to include a spacer layer of semiconductor material, such as InP between the active semiconductor and the surrounding doped layers. The thickness of the spacer layers can be selected to reduce the capacitance of the depletion layer to the required level.

In particular embodiments, the width of the ridge may be greater than 5.5 microns and/or less than 8 microns. A narrower ridge reduces the capacitance of the absorption layer, but also reduces the width of the optical mode.

Viewed from a further aspect, the invention provides a buried hetero structure electroabsorption modulator comprising an absorption layer between at least one layer of p-doped semiconductor and at least one layer of n-doped semiconductor, wherein the absorption layer is formed in a mesa with a width of between 0.6 and 3 microns and the thickness of the absorption layer is between 9 and 65 nm.

According to this aspect of the invention, it has been found that a relatively diffuse optical mode can be achieved using a buried heterostructure geometry.

In the electroabsorption modulator according to this aspect of the invention, the absorption layer may comprise multiple quantum wells, in particular two or three quantum wells. Alternatively, the absorption layer may comprise bulk semiconductor.

The sum of the thicknesses of the multiple quantum wells may be greater than 20 nm and/or less than 40 nm. In particular embodiments, the width of the mesa is greater than 1 micron and/or less than 2 microns.

According to an invention described herein there is provided an electroabsorption modulator where the total thickness of the bulk absorption layer or multiple quantum well absorption region is between 9 and 23 nm.

An electroabsorption modulator according to the invention can be designed to have a coupling loss to cleaved SMF-28® optical fibre or to a lensed fibre of <3 dB, preferably <2 dB, without the need for a tapered waveguide.

The electroabsorption modulator may be a reflective electroabsorption modulator or a dual function electroabsorption modulator photodiode structure.

### BRIEF DESCRIPTION OF THE DRAWINGS

Embodiments of the invention will now be described by way of example only and with reference to the accompanying drawings, in which:

FIG. 1 is a schematic cross section through an electroabsorption modulator structure according to an embodiment of the invention in a plane perpendicular to the direction of optical propagation.

FIG. 2 shows 10% intensity contours of the simulated optical mode at 1550 nm wavelength and TE polarisation for the structure of FIG. 1.

FIG. 3 shows a scanning electron microscope profile of a fabricated dilute mode ridge electroabsorption modulator with 6.4 um ridge width according to an embodiment of the invention.

FIG. 4 shows a scanning electron microscope profile of a fabricated dilute mode ridge electroabsorption modulator with 6.5 um ridge width and 2 quantum wells according to an embodiment of the invention.

FIG. 5 shows the DC insertion loss characteristics of the packaged reflective EAM. Key; grey—1540 nm, black—1550 nm, dashed lines—TE, solid lines—TM polarization.

FIG. 6 shows the frequency response of the reflective EAM measured at −1.5 V bias for input optical powers of 0, +5, +10, and +15 dBm.

FIG. 7 shows the measured 10 Gbit/s eye diagram of the reflective EAM.

FIG. 8 shows 10% intensity contours of the simulated optical mode at 1550 nm wavelength and TM polarisation for a dilute moded buried heterostructure design.

### DETAILED DESCRIPTION OF EMBODIMENTS

The invention provides an electroabsorption modulator with an optical mode dilute enough that coupling to lens fibres can be achieved with reasonably low losses (<3 dB) without the need for a taper. The novel device design has the potential to significantly reduce the cost of packaged single electroabsorption modulators and EAM arrays by significantly increasing their optical mode size to relax alignment tolerances to the input/output fibres. Optoelectronic components designed to have an expanded optical mode profile matched to a cleaved optical fibre can be realised in designs of minimal complexity/cost in which no optical mode transformers or tapers are required.

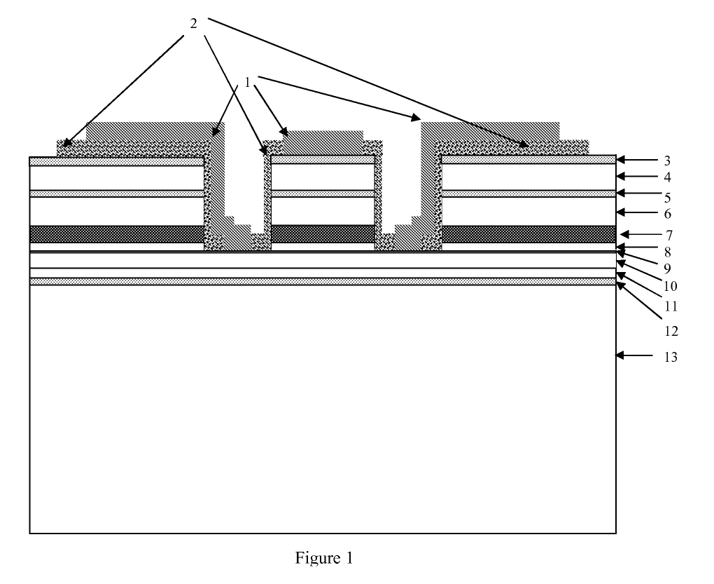

A preferred embodiment of an electroabsorption modulator according to the invention is shown schematically in FIG. 1. In FIG. 1, the electroabsorption modulator comprises, in sequence, a metallic contact layer 1, a dielectric layer 2 and a p+InGaAs contact layer 3. Two layers of p-type InP 4, 6 are separated by a p-type InGaAsP layer 5 whose refractive index is higher than that of the surrounding InP and whose purpose is to help expand the optical mode in the vertical direction.

A region containing the absorption layer or better referred to as the depletion region 7 is a region of the device with low intentional doping that is intentionally depleted when a reverse bias is applied across the PiN junction. Levels of p and n type dopants are preferably less than 1×10¹⁷ cm⁻³ in this region. In this embodiment the depletion region 7 includes several layers of semiconductor: a multiple quantum well (MQW) with two wells preferably composed of InGaAs with three barrier regions preferably composed of InAlAs; a thin InGaAsP layer immediately above and below the MQW. The MQW including their barriers are otherwise known as the absorption layer. The depletion region further comprises InP layers on the outside of the InGaAsP layers. The total thickness of depletion region 7 selected to reduce the capacitance of the device to the required value.

Below the depletion region 7, two n-type InP layers 8 and 10 are separated by a thin n-type InGaAsP layer 9 whose primary purpose is to act as an etch stop layer. Below the etch stop layer, undoped or semi-insulating InP layers 11, 13 are separated by an undoped or semi-insulating InGaAsP layer 12 whose refractive index is higher than that of the surrounding InP and whose purpose is to help expand the optical mode in the vertical direction.

In this embodiment, the ridge width is 7 μm and the ridge height is 3.7 μm. The absorber layer material in depletion region 7 contains only two quantum wells and three barriers and has a total thickness of approximately 37 nm. As shown in the figure, the absorption layer is also of 7 μm width. The absorption layer may also be referred to as an active material layer or region. Alternatively, bulk or quantum dot absorber regions of comparable thickness could be used. Un-etched regions may also be used at various points on the device besides the ridge waveguide for mechanical reasons.

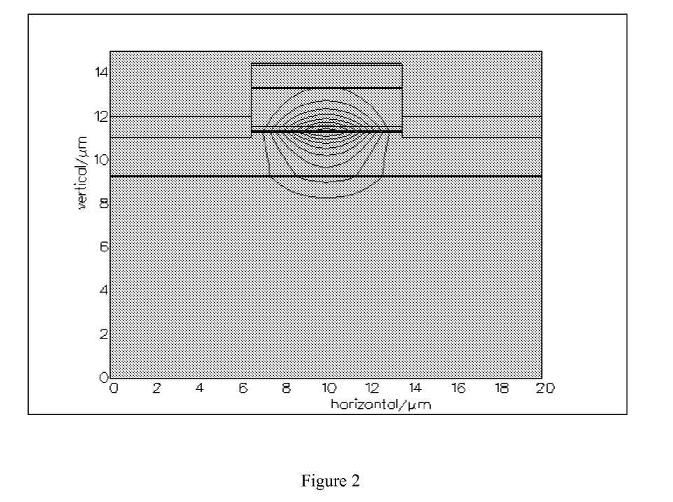

The simulated optical mode of this structure is shown in FIG. 2. Confinement factors within the depletion region 7 are very low (<2%) and so optical power handling is extremely good. Simulated FWHM in intensity vertical/horizontal mode profiles are 9.3 degrees/9.1 degrees for both TE and TM giving predicted coupling losses to cleaved fibre of 1.6-1.8 dB. The depletion region thickness is assumed to be ˜0.11 μm which is unusually thin and this means that absorption happens of a narrow voltage range giving maximum dT/dV values of ˜0.4 V⁻¹ in a 340 μm long reflective EAM (using values of absorption versus voltage achieved in other MQW EAMs) which is a significant improvement over existing devices and would translate into lower system losses in analogue antenna remoting applications, for example. Based on simulated impedances of this structure a 2 GHz 3 dBe bandwidth is expected when matched to 50 Ohms.

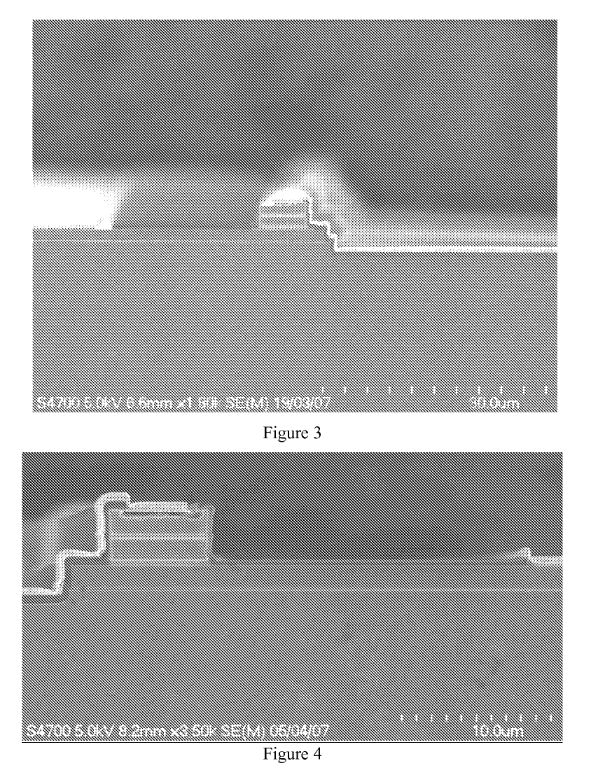

Higher bandwidths could be achieved using a shorter device or a device with a wider depletion region. Simulations based on extrapolating the measured performance of a three quantum well EAM with a 6.4 μm ridge width (shown in FIG. 3) predicted that 10 dB of modulation and approximately 10 GHz bandwidth may be achievable in a ˜150 μm long reflective EAM with two quantum wells. This is significant as this design could find wide application as an arrayed 10 Gbit/s modulator. It may be possible to further extend the bandwidth via travelling wave electrode approaches.

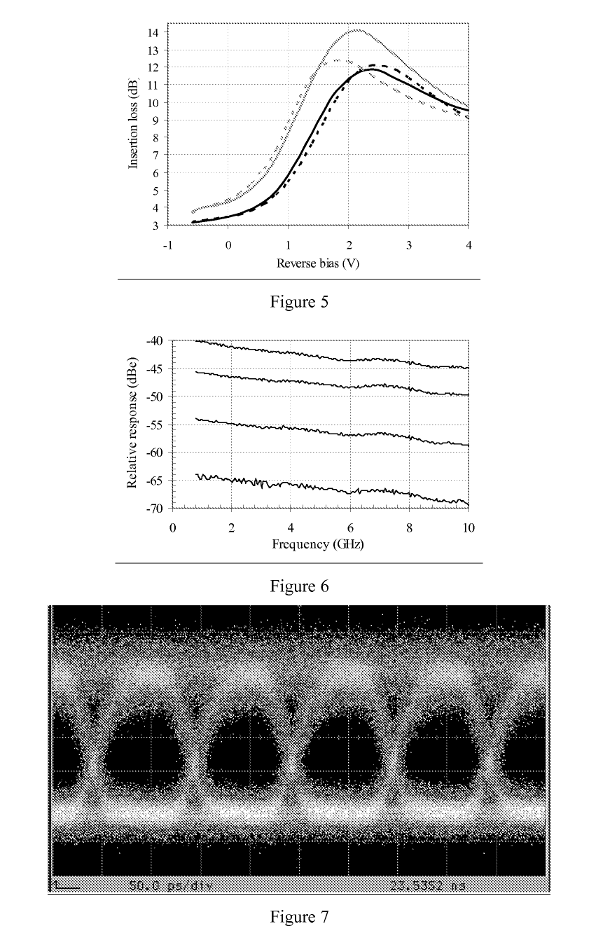

An EAM with two quantum wells, a ridge width of 6.5 μm and ridge height of approximately 3.9 μm has subsequently been made (shown in FIG. 4). The width of the absorption layer and at least one of the p-type semiconductor and n-type semiconductor layers is also of 6.5 μm. The EAM was made from a wafer whose layer structure matches that described in the preferred embodiment except for the presence of an additional very thin InGaAsP layer located at approximately the upper edge of the depletion region. The absorption layer which comprises the MQW structure includes two InGaAs wells and three InAlAs barriers and has a total thickness of approximately 36 nm. The MQW absorber layer lays within a depletion region whose thickness was estimated to be ˜0.22 μm. A 219 μm long reflective EAM from this wafer was packaged in a module in which a lens ended fibre with a specified far-field full width at half maximum intensity mode profile of 10 degrees was used to couple light in and out of the device. The DC characteristics of the packaged reflective EAM were measured at 20° C. using an optical circulator. The measured optical insertion losses including fibre-chip coupling losses but excluding circulator losses are plotted in FIG. 5. At 1550 nm the measured insertion loss was 3.1 dB which is thought to be the lowest reported for an EAM. Despite the very dilute moded structure the double pass configuration enabled an on:off ratio of >8.5 dB to be achieved. The reflective EAM shows a low polarization sensitivity, which could be important in applications where it is at a different site to the laser. The fibre-chip coupling losses were estimated to be only ˜1 dB using measured photocurrent values and insertion losses. The frequency response of the reflective EAM was measured using a lightwave component analyzer at a range of input optical powers. The results plotted in FIG. 6 show that the 3 dBe modulation bandwidth was ˜7.5 GHz. The reflective EAM was then modulated at 10 Gbit/s with a 2.9 Vₚₑₐₖ₋ₚₑₐₖ drive amplitude and 2³¹-1 pseudo random bit sequence. The back to back eye diagram when the reflective EAM was at 20° C. with an input optical power prior to the reflective EAM of +3 dBm and a wavelength of 1550 nm is shown in FIG. 7. An acceptable dynamic extinction ratio of 9 dB and a very low dynamic insertion loss of 6 dB were measured. The measured sensitivity of for example a 10⁻⁹ bit error rate in a pre-amplified optical receiver was −33.8 dBm. The dispersion penalty over 80 km of SMF-28 fibre was determined for the reflective EAM under these conditions. When the modulator reverse bias voltage was increased slightly to optimize the receiver sensitivity after 80 km the measured receiver sensitivity was within 2 dB of the optimum back-back value. These results show that the dilute moded reflective EAM shows a very low insertion loss and has promising characteristics for applications at 10 Gbit/s.

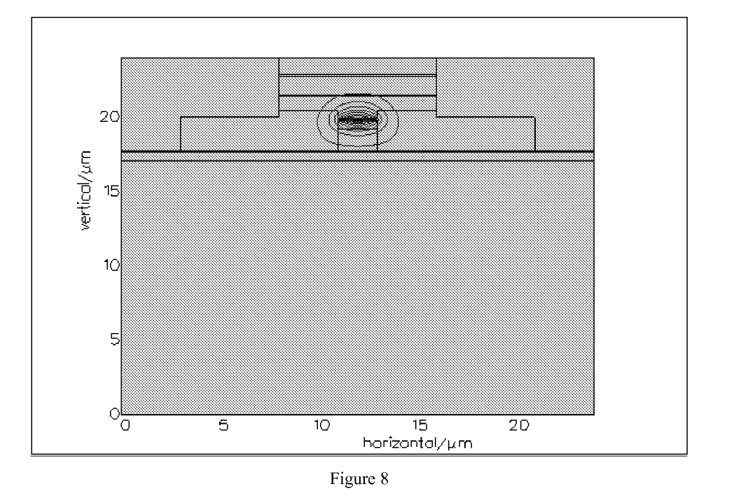

An example of a dilute moded buried heterostructure design according to an aspect of this invention is shown in FIG. 8. The semiconductor layer structure of a vertical section through the central part of the structure in FIG. 8 comprises; a heavily p-doped InGaAs contact layer, p doped InP layers separated by a thin p doped InGaAsP layer (whose purpose is to expand the mode vertically), the depletion region, three n doped InP layers separated by two thin n-doped InGaAsP layers (whose purpose is to expand the mode vertically and the second may also act as an etch stop layer), and an underlying region of semi-insulating InP. The depletion region in the simulated structure comprises a thin upper InGaAsP layer, layers of InP and thin layers of InGaAsP above and below the absorber layer. The absorber layer comprises 3 quantum wells each 11 nm thick and 4 barriers each 5 nm thick. The width of the heavily p doped InGaAs contact layer is 8 μm and the width of the absorber layer is 2 μm. Semi-insulating InP is adjacent to the 2 μm wide mesa which contains the absorber layer. The simulated FWHM in intensity vertical/horizontal far field mode profiles are 9.4 degrees/9.8 degrees for TE and 5.2 degrees/6.6 degrees for TM giving predicted coupling losses to cleaved SMF-28 fibre of 2.4 dB for TE and 1.7 dB for TM polarised light. A low cost expanded mode photodiode can have very similar structure to those described above.

In summary, an electroabsorption modulator comprises a depletion region 7 between at least one layer of p-doped semiconductor 6 and at least one layer of n-doped semiconductor 8. The layers form a ridge waveguide structure. The thickness of the absorption layer which include the MQW and their barriers is between 9 and 60 nm and the width of the ridge is between 4.5 and 12 microns. In particular, the width of the absorption layer is between 4.5 and 12 microns as well as at least one of either the n-type semiconductor layers or of the p-type semiconductor layers.

The design allows EAMs to be passively aligned with passive optical waveguides as part of a hybrid integration scheme for subsystem miniaturisation (G. Maxwell et al, “Very low coupling loss, hybrid-integrated all-optical regenerator with passive assembly” European Conference On Optical Communications, Post Deadline Paper, 2002). Application areas include digital modulation for telecommunications and data-communications and fibre-fed antenna remoting.

1. An electroabsorption modulator comprising an absorption layer, at least one layer of p-doped semiconductor, and at least one layer of n-doped semiconductor, said absorption layer being provided between said at least one layer of p-doped semiconductor and said at least one layer of n-doped semiconductor, and said layers forming a ridge waveguide structure, wherein the thickness of said absorption layer is between 9 and 60 nm, the width of said absorption layer is between 4.5 and 12 microns, and the width of at least one of said at least one layer of p-doped semiconductor and said at least one layer of n-doped semiconductor is between 4.5 and 12 microns; whereby the width of said ridge waveguide structure is between 4.5 and 12 microns.

2. An electroabsorption modulator as claimed in claim 1, wherein said absorption layer comprises multiple quantum wells.

3. An electroabsorption modulator as claimed in claim 2, wherein said absorption layer comprises three quantum wells.

4. An electroabsorption modulator as claimed in claim 2, wherein said absorption layer comprises fewer than three quantum wells.

5. An electroabsorption modulator as claimed in claim 2, wherein the sum of the thicknesses of said multiple quantum wells is between 9 and 40 nm.

6. An electroabsorption modulator as claimed in claim 5, wherein the sum of the thicknesses of said multiple quantum wells is between 18 and 25 nm.

7. An electroabsorption modulator as claimed in claim 1, wherein said absorption layer has a thickness between 20 and 40 nm.

8. An electroabsorption modulator as claimed in claim 1, wherein the width of said ridge waveguide structure is between 5.5 and 8 microns.

9. A buried heterostructure electroabsorption modulator comprising an absorption layer, at least one layer of p-doped semiconductor and at least one layer of n-doped semiconductor, said absorption layer being provided between said at least one layer of p-doped semiconductor and said at least one layer of n-doped semiconductor, wherein said absorption layer is formed in a mesa with a width of between 0.6 and 3 microns and the thickness of said absorption layer is between 9 and 65 nm.

10. An electroabsorption modulator as claimed in claim 9, wherein said absorption layer comprises multiple quantum wells.

11. An electroabsorption modulator as claimed in claim 10, wherein said absorption layer comprises three quantum wells.

12. An electroabsorption modulator as claimed in claim 10, wherein said absorption layer comprises fewer than three quantum wells.

13. An electroabsorption modulator as claimed in claim 10, wherein the sum of the thicknesses of the multiple quantum wells is between 20 and 40 nm.

14. An electroabsorption modulator as claimed in claim 9, wherein said absorption layer has a thickness between 20 and 40 nm.

15. An electroabsorption modulator as claimed in 9, wherein the width of said mesa is between 1 and 2 microns.
